(19) United States
(12) Patent Application Publication
(10) Pub. No.: US 2004/0230487 A1
(43) Pub. Date: Nov. 18, 2004

(54) Local data access system

(76) Inventor: Jeffrey William Tripp, Annandale, NJ (US)

Correspondence Address: IP DEPARTMENT OF PIPER RUDNICK LLP, ONE LIBERTY PLACE, SUITE 4900, 1650 MARKET ST, PHILADELPHIA, PA, 19103, US

(21) Appl. No.: 10/843,170

(22) Filed: May 11, 2004

Related U.S. Application Data
(60) Provisional application No. 60/469,904, filed on May 13, 2003.

(51) Int. Cl. G06F 17/60

(52) U.S. Cl. 705/16

(57) ABSTRACT

A means/product seamlessly gathers and retains data for consumer products and services to enable e-commerce in handheld devices. Data is available at the product and rich enough in content to provide details about the product or service for use in the purchasing decision of the consumer or immediately allow access to additional information through a wireless connection. In one embodiment, the solution utilizes RFID tag technology.

### CROSS-REFERENCE TO RELATED APPLICATIONS

The present application claims priority of U.S Provisional Patent Application Serial No. 60/469,904 filed May 13, 2003, the entire disclosure of which is incorporated by reference herein.

### BACKGROUND OF THE INVENTION

There exists an application for RFID technology that has gone unnoticed and provides a business opportunity to create products for the consumer market that complements the efforts of the retailers and enables efficient electronic/mobile commerce (e-commerce) opportunities. This application will provide consumers with valuable point of service information and will support the retailers' efficiency goals and the manufacturers brand awareness, while providing technical simplicity and helping to create more value for RFID devices by creating the broadest application of the technology that is possible.

It is possible to create product and service to leverage the deployment of the next generation RFID tags and provide consumers with a simple, affordable, and interactive wireless data link to download product specifications or information to handheld devices seamlessly, while providing retailers with an efficient mode of ecommerce.

### SUMMARY OF THE INVENTION

Consumers have many handheld devices available that can be used to store data and information or access information remotely. Today, this information is stored in a detached way for close association for the consumer to use effectively or in not enough detail to prove effective. If more information was immediately and seamlessly available for the consumer, this data could be used to provide details about products, enhance services, or provide directions. Having this information would create more awareness for the consumer and allow for faster purchasing decisions to be made. Allowing products to be updated with this latest information can assist the product marketing teams in point of sale advertising and provide a new tool in their quest to optimize the product flow through the channels.

The following discussion introduces a concept for information gathering and applications for its use. The information is focused on products, although, there are service applications and business opportunities also available, as previously discussed. The technological aspects will be discussed in the following section. In general, the use of existing technological devices is used in a new way creating a novel device and application.

### BRIEF DESCRIPTION OF THE DRAWINGS

FIG. 1 is an exemplary diagram in accordance with an embodiment of the present invention.

FIG. 2 is an exemplary diagram in accordance with an embodiment of the present invention.

FIG. 3 is an exemplary diagram in accordance with an embodiment of the present invention.

FIG. 4 is an exemplary diagram in accordance with an embodiment of the present invention.

FIG. 5 is an exemplary diagram in accordance with an embodiment of the present invention.

### DETAILED DESCRIPTION

It is proposed to introduce a means/product to seamlessly gather and retain data for consumer product and services to enable e-commerce in handheld devices. Data would be immediately available at the product and be rich enough in content to provide details about the product or service for use in the purchasing decision of the consumer or immediately allow access to additional information through a wireless connection. The proposed solution would tap into the emerging RFID tag technology. The consumer would either purchase add-on products for wireless products such as PDA's, (portable handheld devices) and cellular phones or purchase a handset with access capability included. The modules would interface directly to these handheld devices, tapping into an already embedded base. The consumer, on demand, would operate the devices/reader. This would be accomplished by having the consumer approach a product of interest and wave their handheld device near the product to extract the information provided. The data would be loaded into the handheld unit for review, storage, or seamless data access through a wireless data link. The transaction is simple and efficient, but yet provides information to the consumer that could be valuable in making a purchase, at the point of sale.

Manufacturers or retailers would embed/attach RFID tags into their products. As the devices are programmable, the both the retailer or the manufacturer could modify the contents of the device to provide up to date information about a product that would be useful to the consumer on top of the baseline information such as product features, model numbers, etc. In fact, the RFID tags memory can be scaled to provide increasing content for more sophisticated or expensive items. Additionally, the client software would also create a data link, allowing the consumer to immediately access more information. All of this would take place automatically, after the consumer decides to look for additional information.

The retailer and manufacturer would now have at their disposal, a powerfull new marketing tool. Now that information can be updated in real-time for the consumer, marketing teams can test different forms of content at the point of sale to sway the thoughts of the consumer.

To promote the use of this e-commerce method the new business would design ID readers to be integrated or added onto portable handheld devices. This would provide consumers to have this option available in many forms such as mobile phones, personal PDA's or possibly shopping carts with readers embedded.

To implement this concept.

1) Reader and the associated content in the RFID tag

2) Client software residing on the handheld device

3) Carrier grade software to create efficient data connections

4) Database service and web-based database software.

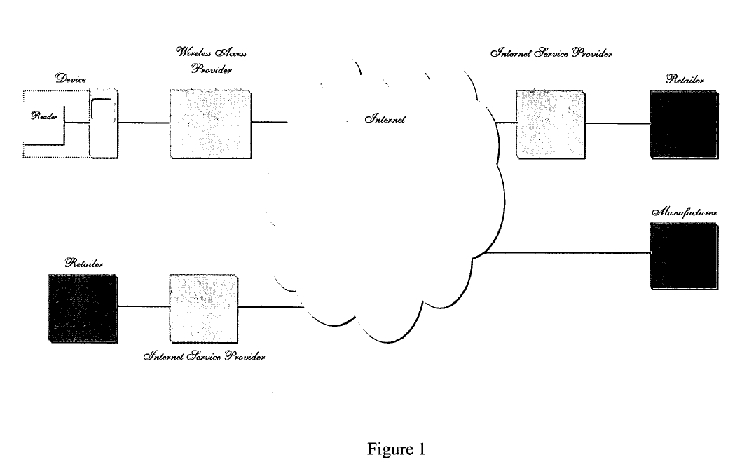

The diagram in FIG. 1 is a simple system representation. Contained within the Internet cloud are the routers and access devices that create the connections throughout the network.

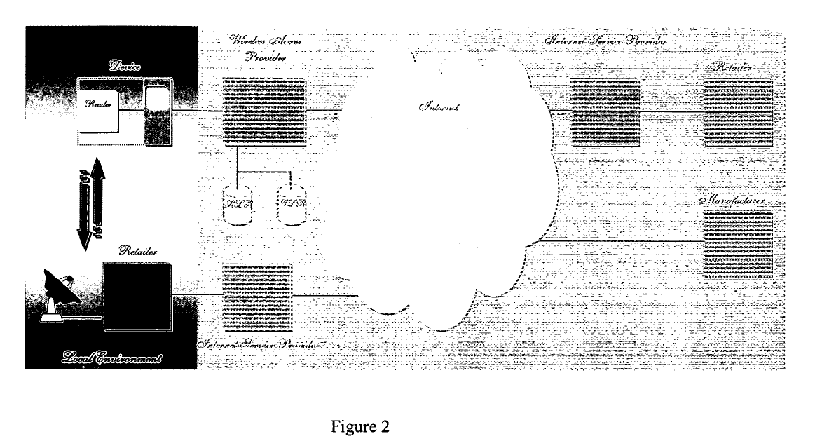

The first 3 areas of technology innovation are centered on the local environment as highlighted in FIG. 2. That is, a subsystem exists that includes the RFID tag, the reader and the client software. Add this capability to a local environment and content can be made available to the user from the tag or from the retailer directly. Entire transactions can take place within this environment without interaction to other parts of the system.

Within the local environment, then, the retailer can configure (or allow configuration) a set of RFID tags and also read these tags for inventory control. Further, the retailer can allow transactions to occur directly through the access point from the handheld device. Instead of obtaining more information through the internet or through the internet to the retailer indirectly, the user can access this through the retailers' access point/reader. As the user enables a RFID tag transaction, the client software on the handheld device can now display the RFID tag contents or enable a connection to the local environment through the access points to allow further content from the local source. The user now has the ability to select some level of security as the transaction is completed within the domain of the environment they are physically located within. The retailer can then control data transactions and choose to offer and support a level of service locally that would be greater then accessing the other environments. This could also be linked in closely with the purchasing equipment of the retailer and allow for instantaneous transactions to take place between the retailer equipment (cash register) and the users handheld device (cellular phone). Transaction information can be available in the handheld unit and transferred securely to the retailer to complete a purchase, seamlessly. This environment not only uses the previously discussed hardware and clients, but also enables other software and services to be provided to support this capability at the retailer.

Generally, the system as described is very flexible and can be implemented using technology that is available today. It offers capabilities to expand the content through RFID tags (in any band, though UHF and microwave are highlighted for use with a handheld device such as a cell phone) with more memory as they technology is improved or provides seamless access to predetermined content for the user to review.

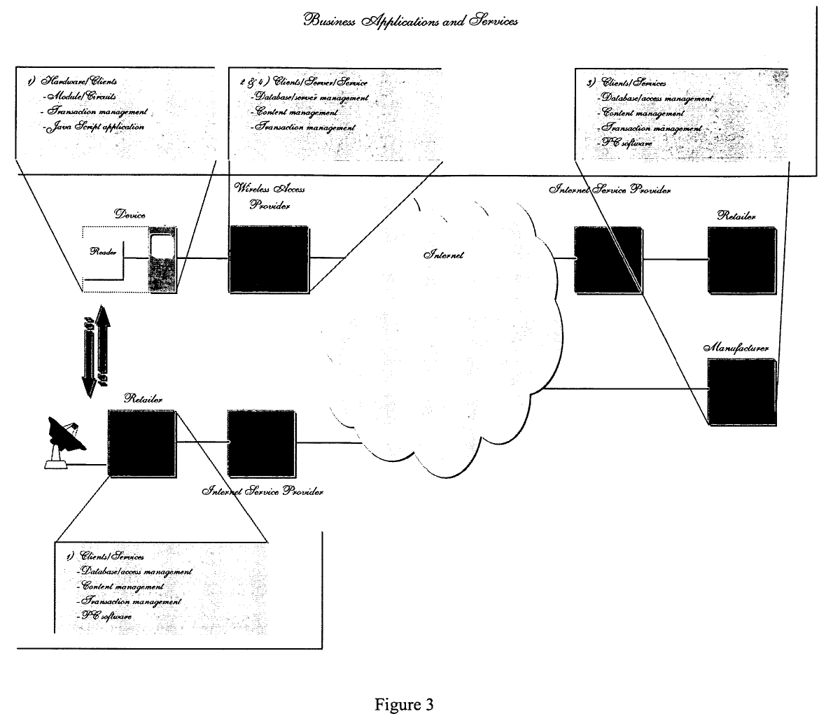

Referring to FIG. 3, the first area to consider is the reader itself, the modules, circuits, clients and intellectual property licensing. The first goal is to create a community of handheld devices that have the capability to access RFID tags and create the appropriate links to drive the content server. This can be achieved in several methods. First, completely new modules are created that clip, interface, or integrate to a handheld device. The users will be able to access this capability directly from their handheld devices and download the client from our web-server on a fee-based basis

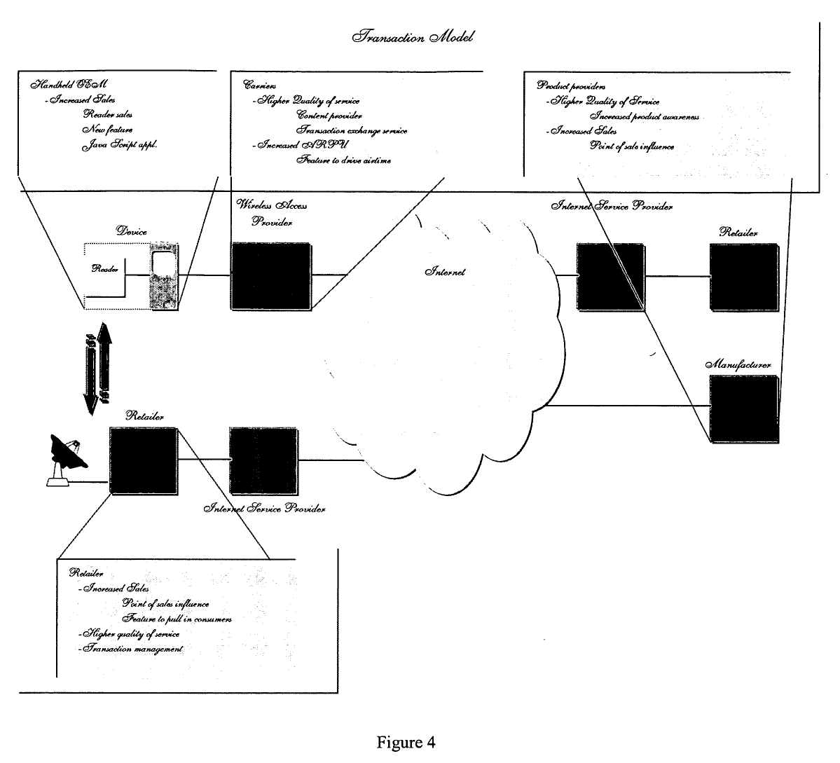

Expanding on the readers and the creation of local environment, an interesting application exists. This technology allows any retailer, regardless of size, to tailor this system for their own needs and provide better service to the consumer on demand. In this method the handhelds is capable of multi-function access to both the RFID tag and a standard 802.11 or Bluetooth access point. With this capability, now the retailer can have the consumer direct all RFID reader inquiries directly to the retailer. In accomplishing this, the retailer would set up a local wireless network and data server. The retailer would then supply additional information on the server as the consumer accesses the RFID tags. To support this unique application, the client on the handheld would recognize the environment through reading of one or more RFID devices and direct the access to take place at the local level. PC software would establish both the access link capability into their local wireless network and provide the capability to create a database of information. This software package would work on any operating system and personal computer or server available. Additionally, services can be created to support this application. Most notably, create and support content that is downloaded into the database on regular basis and include requests for additional content. This is an excellent opportunity to provide consistent information to similar businesses above and beyond local customization that can still take place. This model can be scaled and adjusted from small individually owned businesses to large scale national retailers. It is important to recognize some of the transactions that take place, as outlined in FIG. 4, within the environments and possible alternative capabilities never before available. In general, each entity will benefit from the increased service capabilities.

One of the most important features within each of the environments is the ability to provide the individual consumer with information at the time of a purchase decision. The goal of the retailer is to increase sales, while the goal of the manufacturer would be to influence the product selection. The service provider would benefit through increased usage on their system and access to the mobile consumer. The mobile consumer benefits by obtaining information pertaining to desired decision points and the satisfaction of making an educated purchase. The Local environment is outlined in FIG. 2.

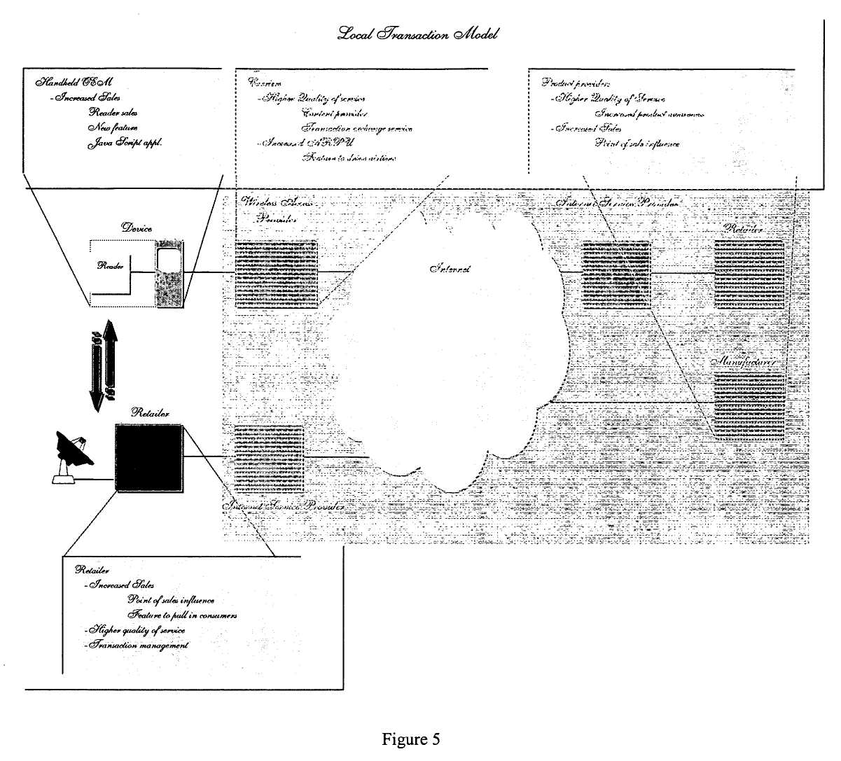

When considering the local environment, the retailer is the central transaction point for the consumer, as highlighted in FIG. 4 and FIG. 5. The retailer looking for differentiation through improved service will benefit from this new system. The retailer will have the ability to increase sales through unique individual marketing at the point of sales, by increasing the quality of service. As retailers have reduced staffing in recent times, quality of service has also dropped. Here is a tool to assist in the sales aspect of the business that can be tailored to the individual or the masses. Through innovative technology, the mobile consumer will be capable of discovering additional information from the retailer about products being sold at the outlet and increase the likelihood to make an immediate purchase. Additionally, the retailer has the opportunity to capture the attention of the Consumer as the system allows for a complete local environment to be created and administered by the Retailer. Further, the retailer has the opportunity to increase transaction and inventory efficiency to reduce costs.

Overall, the system outlined, provides enhanced revenue opportunities for businesses by accelerating consumer purchases in the market.

Although the invention has been described in terms of exemplary embodiments, it is not limited thereto. It will also be appreciated that a system in accordance with the invention can be constructed in whole or in part from special purpose hardware or from conventional general purpose hardware or any combination thereof, any portion of which may be controlled by a suitable program. Any program may in whole or in part comprise part of or be stored on a system in a conventional manner, or remain whole or in part be provided into the system over a network or other mechanism for transferring information in a conventional manner. Accordingly, it is understood that the above description of the present invention is susceptible to considerable modifications, changes and adaptation by those skilled in the art, and that such modifications, changes and adaptations are intended to be considered within the scope of the present invention, which is set forth by the appended claims. The invention having been described, it will be apparent to those skilled in the art that the same may be varied in many ways without departing from the spirit and scope of the invention. Any and all such modifications are intended to be included within the scope of the following claims.

What is claimed is:

1. A method adapted to enable a retailer to provide data transactions and choose to offer and support a level of service locally to products on hand comprising:
providing information regarding one or more products or services to retailers and customers through a local wireless network; and
providing one or more portable wireless devices for access to the information via the local wireless network.

2. A method of claim 1, wherein the information comprises one or more selected from the group consisting of:
interactive offers comprising one or more items selected from the group consisting of services, discounts, upgrades and bundled packages; and
product details of one or more criteria from the group consisting of specifications, uses, history, comparisons, cost, price, ingredients, complimentary products, location, alternative products, safety, interaction with other products, size, dimension, manufacturer, environment and performance.

3. A method of claim 2, wherein the interactive offers are marketed through the wireless link to the consumer personal wireless device.

4. A method of claim 3, wherein the interactive offers are determined from the wireless device reading radio frequency tags and using this information to access data through the wireless link.

5. A method of claim 1, wherein the information is provided near the time of purchase or data is available in the proximity or location of a product.

6. A method to link data inquiries closely with equipment of a retailer and to allow for instantaneous transactions to take place between retailer and a customer comprising a customer device, a retailer device and a data link for communicating between the customer device and the retailer device.

7. A method of claim 6, wherein the data link comprises a wireless network.

8. A method of claim 6, wherein the customer device comprises a handheld wireless device.

9. A method of claim 6, wherein the retailer device comprises a device for electronic funds transfer.

10. A method of claim 6, further comprising a wireless identification tag containing information regarding a product or service and the handheld wireless device accessing the information contained in the wireless identification tag.

11. An apparatus adapted for multi-function access to both an RFID tag and a wireless network comprising:
a portable wireless device including a software client that both recognizes an environment through reading of one or more RFID devices and regulates access to a local wireless network; and
a local data server including software to establish both access link capability into the local wireless network via the portable device and to provide the capability to create a database of information stored from external sources.

12. An apparatus of claim 11, wherein a user of the portable wireless device can disable the software client or re-direct access to another wireless link.
